(19) United States
(12) Patent Application Publication
(10) Pub. No.: US 2010/0319187 A1
(43) Pub. Date: Dec. 23, 2010

(54) Manufacturing Method of Stacked Electrodes By Winding Type Electrode Stacking and Stacked Electrode Thereby

(75) Inventors: Young Jae Kim, Chungju-si (KR); Han Sung Lee, Chungju-si (KR); Gyu Sik Kim, Cheongwon-gun (KR); Jong Man Woo, Chungju-si (KR)

Correspondence Address: REINHART BOERNER VAN DEUREN P.C., 2215 PERRYGREEN WAY, ROCKFORD, IL, 61107, US

(73) Assignee: Enertech International, Incorporated, Chungju-si (KR)

(21) Appl. No.: 12/549,858

(22) Filed: Aug. 28, 2009

(30) Foreign Application Priority Data
Jun. 22, 2009 (KR) 2009-55637

(51) Int. Cl. H01M 4/82

(52) U.S. Cl. 29/623.1

(57) ABSTRACT

The present invention relates to a electrode stacking method, wherein electrodes are stacked in such a manner that the electrodes are disposed to face each other on both sides of a separation layer to which predetermined tension force is applied along the longitudinal direction of said separation layer, and the electrode assembly is turned so that another separation layer is formed outside the electrodes. According to the rechargeable lithium ion batteries in accordance with the present invention, the electrode stack in which the arrangement of anode electrodes and cathode electrodes is not disordered because uniform stress is applied to the entire battery and the separation layer maintains a constant tension force can be fabricated. Accordingly, the lifespan of a rechargeable lithium ion battery can be increased, and the input and output characteristic of the battery can be improved.

### CROSS-REFERENCE TO RELATED PATENT APPLICATIONS

This patent application claims the benefit of co-pending Korean Patent Application No. 2009-55637, filed Jun. 22, 2009, the entire teachings and disclosure of which are incorporated herein by reference thereto.

### BACKGROUND OF THE INVENTION

1. Field of the Invention

The present invention relates to a method of manufacturing a stack for a rechargeable lithium ion battery and an electrode stack fabricated using the method. More particularly, the present invention relates to a winding-type electrode stacking method, wherein electrodes are stacked in such a manner that the electrodes are disposed to face each other on both sides of a separation layer to which predetermined tension force is applied along the longitudinal direction of the separation layer and the electrode assembly is turned so that another separation layer is formed outside the electrodes, and to an electrode stack for a rechargeable lithium ion battery fabricated using the method.

2. Background of the Related Art

With the development of the information communication industry, the use of portable devices continues to increase, and the need for rechargeable lithium ion batteries having a high capacity, a high performance, and a long lifespan required to meet the high performance and multi-function of portable devices also continues to increase. In recent years, active development has been made in rechargeable lithium ion batteries for electric vehicles or hybrid electric vehicles. Thus, active research has been done more on batteries with high capacity, high input, high output, and longer lifespan characteristics than on the existing rechargeable lithium ion batteries for medium/small-sized portable electronic devices. Accordingly, there is a tendency that research on an assembly method of a rechargeable lithium ion battery continues to increase.

A conventional assembly method of a rechargeable lithium ion battery chiefly classified into two groups, a jelly roll type and a zigzag stacking type. A jelly roll type is a method of winding a cathode electrode and an anode electrode with a separation layer interposed therebetween using a process called a winding method, a zigzag stacking type is a method of stacking an anode electrode, a separation layer, and a cathode electrode with a predetermined area maintained there-between. From the two methods, electrodes are typically fabricated as shown in FIGS. 1 and 2. In general, the anode electrode is smaller in size than the cathode electrode, and the anode electrode must be placed within the size of the cathode electrode with the separation layer interposed therebetween. If the size of the anode electrode is larger than that of the cathode electrode or the anode electrode is stacked out of the cathode electrode, a side reaction is generated at a portion of the cathode electrode where the anode electrode is out of the cathode electrode, thereby forming lithium dendrite and so shortening drastically the lifespan of a lithium ion battery. Furthermore, the lithium dendrite formed by the side reaction can cause short-circuit by which the anode electrode and the cathode electrode are electrically connected to each other. In this case, the lithium ion battery may encounter a dangerous situation.

FIG. 1 is an exemplary view showing a method of manufacturing a rechargeable lithium ion battery using a conventional zigzag stacking method. As shown in FIG. 1, in the conventional zigzag stacking method, an anode electrode 121a, a separation layer 110, and a cathode electrode 122a cut according to predetermined sizes are alternately stacked in this order, thereby forming an electrode stack for a rechargeable lithium ion battery 161. In this method, the anode electrodes 121a and the cathode electrodes 122a are disordered in a handling process subsequent to the stacking process because the tension force of the separation layer 110 configured to surround the anode electrodes 121a and the cathode electrodes 122a during the stacking process is weak. In this case, a disordered portion 180 where the cathode electrode 122a slides from the anode electrode 121a is generated, thereby causing a side reaction. Furthermore, after the electrodes are completed, a marginal portion 190 exists between each of the electrodes and the separation layer. Thus, upon charge and discharge of a battery, the external appearance of the battery is swollen by floating matters within the battery.

FIG. 2A is an exemplary view showing an electrode stack for a rechargeable lithium ion battery manufactured by conventional winding type stacking method, and FIG. 2B is an exemplary view showing a deformation of the rechargeable lithium ion battery fabricated using the winding method. This method, as shown in FIG. 2B, is problematic in that the lifespan of the battery is reduced during a long-term charge and discharge process because of the difference in the stress concentrated on the edges and central potions of a rolled cell.

### SUMMARY OF THE INVENTION

Accordingly, the present invention has been made in view of the above problems in the prior art, and one object of the present invention is to provide a method of manufacturing a electrode stack for a rechargeable lithium ion battery, which is capable of increasing the lifespan of a battery by minimizing a marginal portion between a separation layer and an electrode and making uniform stress applied to the front surface of the battery.

Another object of the present invention is to provide an electrode stack fabricated using the above-described method.

Still another object of the present invention is to provide a rechargeable lithium ion battery using the above-described electrode stack.

According to an embodiment of the present invention, there is provided a method of manufacturing a electrode stack for a rechargeable lithium ion battery, comprising the steps of:
forming a unit electrode body by stacking a separation layer to which predetermined tension force is applied along the longitudinal direction of said separation layer, a first electrode on a side of the separation layer, and a second electrode on the other side of the separation layer;
winding the unit electrode body by 180° around a rotation axis which is located at a center of the unit electrode body and is perpendicular to a longitudinal direction of the separation layer, thereby completing a first-step stack;
stacking a third electrode on the separation layer placed outside the first electrode and a fourth electrode on the separation layer placed outside the second electrode and then winding the unit electrode body by 180° around the same rotation axis in the same direction, thereby completing a second-step stack; and
stacking a predetermined number of electrodes through repetitive stacking and winding of the electrodes in the same manner and then driving both ends of the separation layer to one side, thereby completing a final electrode stack.

Here, the first electrode and the fourth electrode may have the same polarity (e.g., the anode or the cathode), and the second electrode and the third electrode may have the same polarity (e.g., the cathode or the anode), but have a different polarity from the first electrode and the fourth electrode.

According to another embodiment of the present invention, the first electrode and the second electrode of the unit electrode body may be single side electrodes, and the single side electrodes are arranged so that inactive faces are opposed each other with the separation layer interposed there-between. In this case, the single side electrodes with the separation layer interposed there-between may have anode and anode polarities, cathode and cathode polarities, or anode and cathode polarities, respectively.

### BRIEF DESCRIPTION OF THE DRAWINGS

Further, objects and advantages of the invention can be more fully understood from the following detailed description taken in conjunction with the accompanying drawings in which:

FIG. 1 is an exemplary view showing an electrode stack for a rechargeable lithium ion battery manufactured by zigzag stacking method;

FIG. 2A is an exemplary view showing an electrode stack for a rechargeable lithium ion battery manufactured by conventional winding type stacking method;

FIG. 2B is an exemplary view showing deformation of the rechargeable lithium ion battery of FIG. 2A;

FIGS. 3A to 3E are exemplary views showing a method of manufacturing an electrode stack for a rechargeable lithium ion battery according to an embodiment of the present invention;

FIG. 4 is a cross-sectional view of the electrode stack for a rechargeable lithium ion battery fabricated according to the embodiment of the present invention;

FIG. 5 is an exemplary view showing that electrodes stacked in an initial unit electrode body in the method of manufacturing the electrode stack for a rechargeable lithium ion battery according to the embodiment of the present invention are single side electrodes;

FIG. 6A is a graph showing the evaluation results of the lifespan characteristics of the batteries fabricated according to one or more embodiments of the present invention and batteries fabricated according to comparative examples; and

FIG. 6B is a graph showing the evaluation results of the output characteristics of the batteries fabricated according to one or more embodiments of the present invention and batteries fabricated according to comparative examples.

### DESCRIPTION OF REFERENCE NUMERALS OF PRINCIPAL ELEMENTS IN THE DRAWINGS

| | |
|---|---|
| 110: separation layer | 121: first electrode |
| 121a: anode electrode | 122: second electrode |
| 122a: cathode electrode | 123: third electrode |
| 124: fourth electrode | 140: first-step stack |
| 130: unit electrode body | 160: final electrode stack |
| 150: second-step stack | 125, 125: single side electrode |
| 171, 172: separation layer roll | |
| 180: disordered portion | 190: marginal portion |

### DETAILED DESCRIPTION OF THE PREFERRED EMBODIMENT

One or more embodiments of the present invention will now be described in detail with reference to the accompanying drawings.

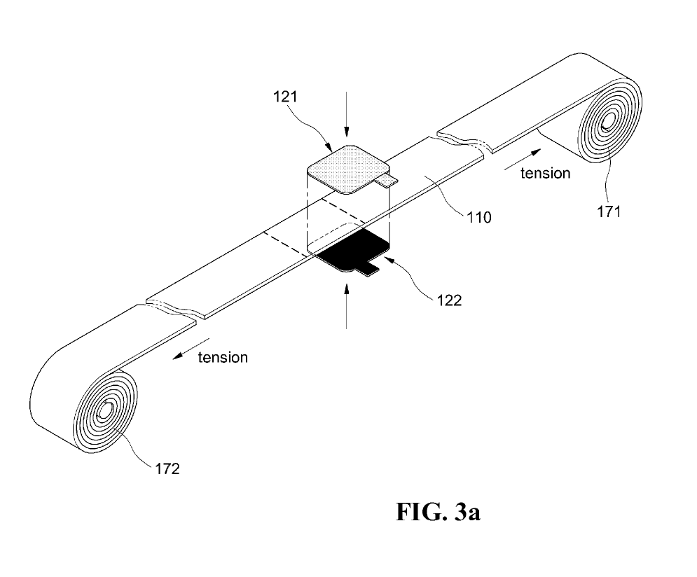

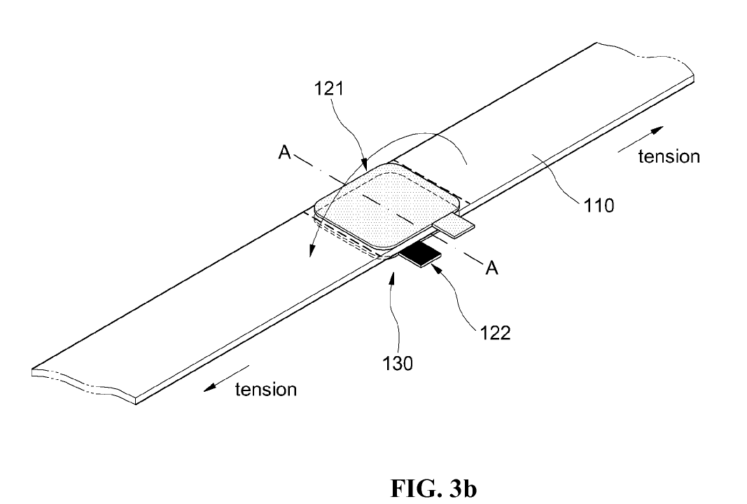

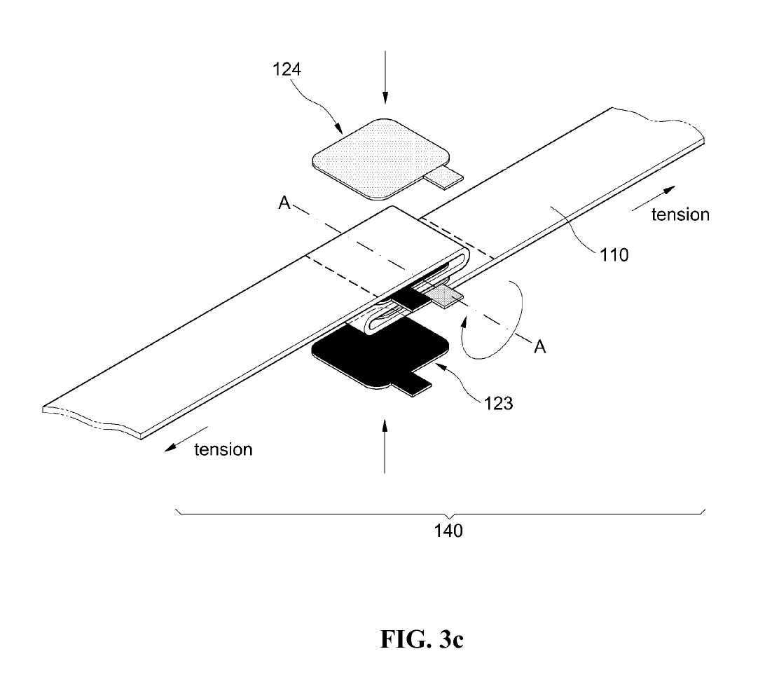

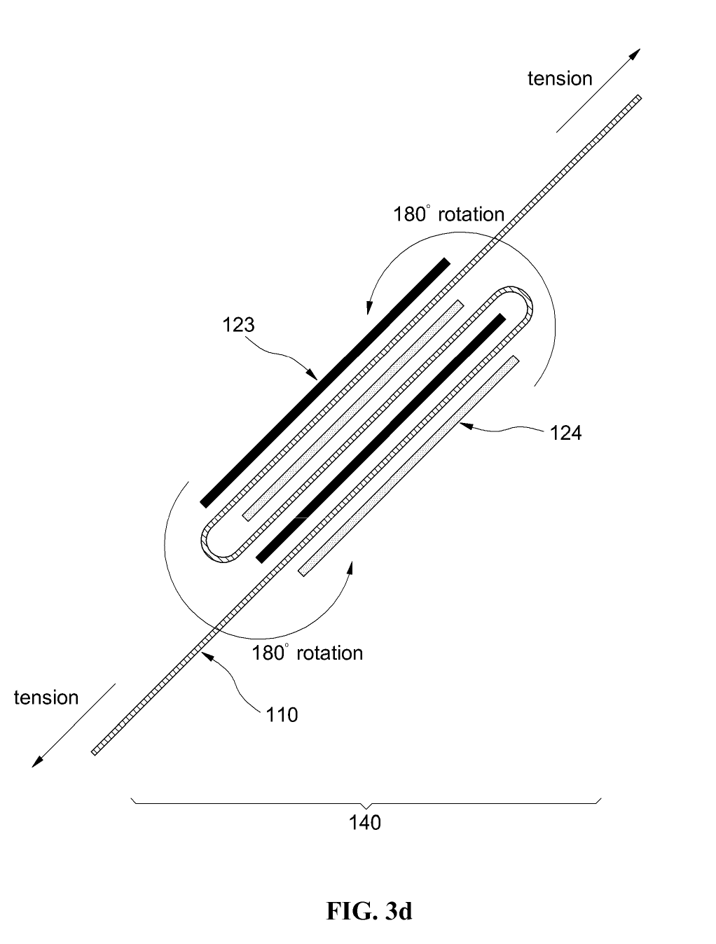

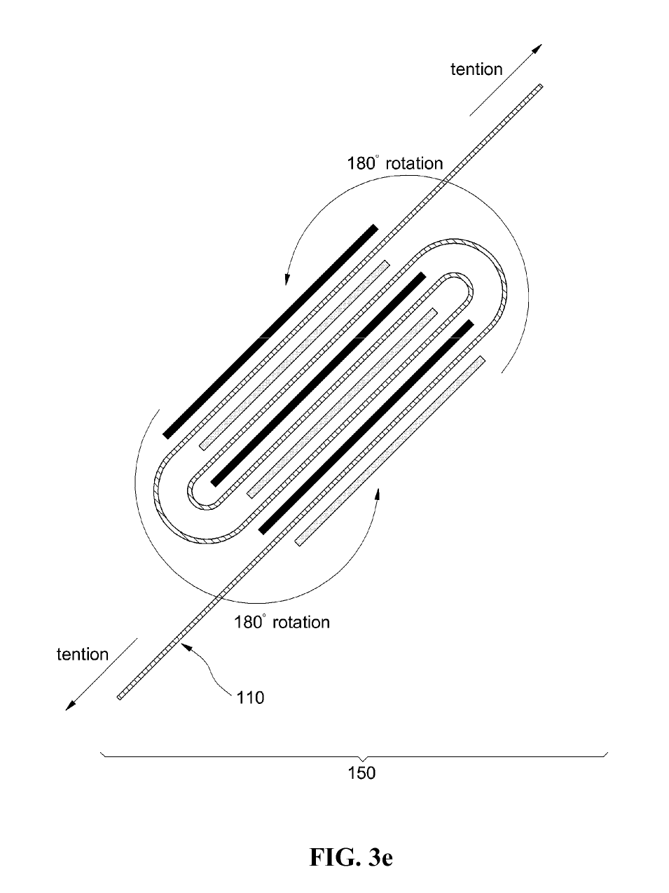

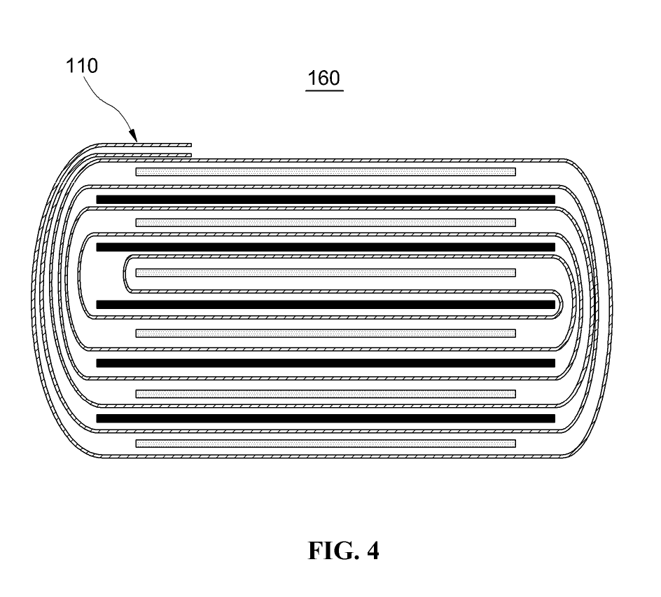

FIGS. 3A to 3E are exemplary views showing the method of manufacturing the electrode stack for a rechargeable lithium ion battery according to the embodiment of the present invention. In the method of manufacturing the electrode stack for a rechargeable lithium ion battery according to the embodiment of the present invention, a unit electrode body 130 is formed by staking a first electrode 121 on one side of a separation layer 110 configured to maintain a predetermined tension force along the longitudinal directions and stacking a second electrode 122 on the other side of the separation layer 110. The unit electrode body 130 is wound by 180° around a rotation axis which is located at the center of the unit electrode body 130 and is perpendicular to the longitudinal direction of the separation layer 110, thereby completing a first-step stack 140. A third electrode 123 is stacked on the separation layer 110 placed outside the first electrode 121, and a fourth electrode 124 is stacked on the separation layer 110 placed outside the second electrode 122. The unit electrode body 130 is then wound by 180° around the same rotation axis in the same direction, thereby completing a second-step stack 150. The predetermined number of electrodes is stacked through repetitive stacking and winding of the electrodes in the same manner. Next, both ends of the separation layer 110 are driven to one side, thereby completing a final electrode stack 160.

The stacked first to fourth electrodes may be of any form, so long as the anode and the cathode are separated from each other so that they can have a battery structure. For example, in one or more embodiments of the present invention, the first electrode 121 and the fourth electrode 124 may have the same polarity (i.e., the anode or the cathode), and the second electrode 122 and the third electrode 123 may have the same polarity (i.e., the cathode or the anode), but have a different polarity from the first electrode 121 and the fourth electrode 124.

FIG. 4 is a cross-sectional view of the electrode stack for a rechargeable lithium ion battery fabricated according to one embodiment of the present invention. In FIG. 4, the electrode stack 160 of the present invention is illustrated to have the anode electrodes and the cathode electrodes alternately stacked with the separation layer 110 interposed therebetween. However, electrodes with the same polarity are finally formed on one side of the separation layer 110, and electrodes with an opposite polarity are finally formed on the other side of the separation layer 110. Furthermore, in the state in which a predetermined tension force is applied to the separation layer 110 in both directions, the electrode body is assembled around the rotation axis. Thus, after the final electrode assembly 160 is completed, the electrodes cannot slide or be twisted, so that a marginal portion does not exist between the electrodes and the separation layer, on each side of the electrode stack.

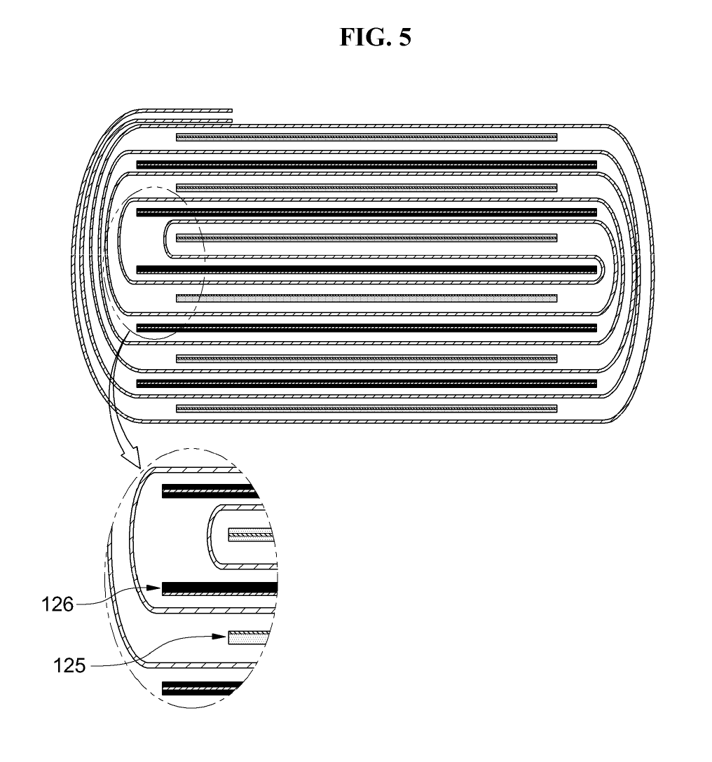

FIG. 5 is a diagram showing another embodiment of the present invention. In another embodiment of the present invention, the first electrode 121 and the second electrode 122 of the unit electrode body 130 are single side electrodes 125 and 126. A single side electrode here-in means the electrode of which only one face is active electrode. The single side electrode can be obtained by coating the active material only to the single side of charge collector. In this case, single side electrodes are arranged so that inactive faces are opposed each other with the separation layer interposed there-between. The single side electrodes 125 and 126 with the separation layer 110 interposed therebetween may have the anode and anode polarities, the cathode and cathode polarities, or the anode and cathode polarities, respectively. In the case where the single side electrodes have the anode and anode polarities or the cathode and cathode polarities, stacking may begin without inserting electrodes into the innermost separation layer.

In the present invention, no special limitations are imposed on a method of applying or maintaining tension force along the longitudinal direction of the separation layer 110. For example, tension force may be applied to the separation layer 110 through two separation layer rolls 171 and 172 (refer to FIG. 3A) provided at both ends of the separation layer 110 in the longitudinal direction thereof. Alternatively, tension force may be applied to only one side of the separation layer 110, or tension force may be maintained over the entire separation layer by force generated when the stack is wound.

Furthermore, additional processing or process in order for the electrode stack 160 to be used in a rechargeable lithium ion battery may be added to the manufacturing method according to the present invention.

Hereinafter, one or more embodiments of the present invention are described in detail. It is, however, to be understood that the embodiments are only illustrative in order to describe the present invention in more detail, and the scope of the present invention is not limited to the embodiments.

### Embodiment 1

An anode electrode (i.e., the first electrode 121) was fabricated by mixing lithium nickel cobalt manganese oxide (LiNiₓCo_{y}Mn_{z}O₂) (i.e., an anode-active material), carbon black (i.e., a conductive material), and PVDF (i.e., a binder) with an NMP (N-methyl pyrrolidone) solvent to thereby obtain a slurry, coating the slurry on an Al charge collector, and drying the result. A cathode electrode (i.e., the second electrode 122) was fabricated by obtaining a slurry having the same composition except that graphite is used instead of lithium transition metal oxide in the composition of the anode electrode, coating the slurry on a Cu charge collector, and drying the result.

Each of the anode electrode and the cathode electrode was punched according to design dimensions, but the size of the cathode electrode was designed greater than the area of the anode electrode. A porous film made of polyethylene materials was used as the separation layer 110. The separation layer 110 was cut in the longitudinal direction of the cathode electrode in order to prevent the cathode electrode and the anode electrode from coming into contact with each other. As shown in FIG. 3A, any one of the separation layer rolls 171 and 172 on both sides was pulled outward with some elastic force such that the electrode could be stacked at the central point of the separation layer designed on one axis on which the separation layer was wound. As shown in FIGS. 3B to 3E, the anode electrode and the cathode electrode were wound by the separation layer, maintaining a predetermined tension force, while rotating them by 180° around the unit electrode body 130 on which the anode electrode and the cathode electrode were stacked to face each other with the separation layer interposed therebetween in one direction. Electrodes were stacked thereon and then rotated, thereby completing the first-step stack 140. Next, the second-step stack 150 was completed through stacking and winding. This process was repeatedly performed thirty times, and the separation layer 110 was driven to one side to thereby complete the final electrode stack 160 according to the present invention.

After the electrode stacks were assembled through the above method, the assembly was inserted into an aluminum pouch, and the remaining faces of the assembly other than one face were sealed, thereby completing a rechargeable lithium ion battery. Then, a lithium salt-containing carbonate-based nonaqueous electrolyte was injected into the rechargeable lithium ion battery, which was then sealed under vacuum. After an electrolyte was sufficiently impregnated in the electrodes, the rechargeable lithium ion battery experienced a charge and discharge process.

### Embodiment 2

An electrode stack and a rechargeable battery using the same were fabricated in the same manner as the above-described embodiment 1 except that the same anode and cathode electrodes as those of the embodiment 1 were used, but both ends of the separation layer is pulled out from the two separation layer rolls 171 and 172 and coupled together.

### Embodiment 3

An electrode stack and a rechargeable battery using the same were fabricated in the same manner as the above-described embodiment 1 except that the same electrode stack as that of the embodiment 1 was used, but in the process of forming the unit electrode body, the anode electrodes initially stacked had only one sides coated and dried, as shown in FIG. 5. As can be seen from the innermost electrodes of the electrode assembly shown in FIG. 5, the section electrodes 125 and 126 each having only one side coated with slurry were used in the anode charge collector, but the other sides of the section electrodes 125 and 126 were not coated with the slurry and were disposed to face each other.

### COMPARATIVE EXAMPLE 1

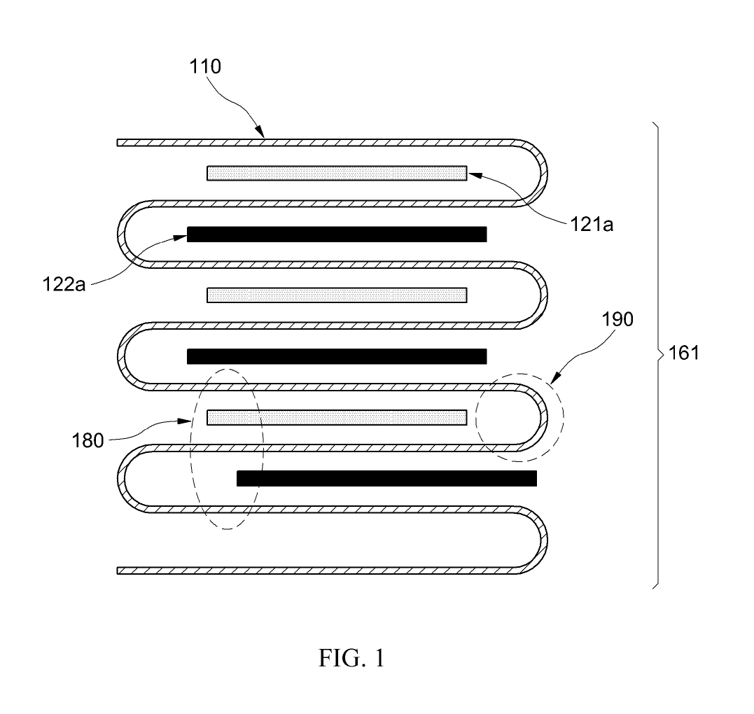

The same electrode material as that of the embodiment 1 was used, but an electrode stack was fabricated using the conventional zigzag stacking method as shown in FIG. 1 and a rechargeable battery using the electrode stacks was assembled.

### COMPARATIVE EXAMPLE 2

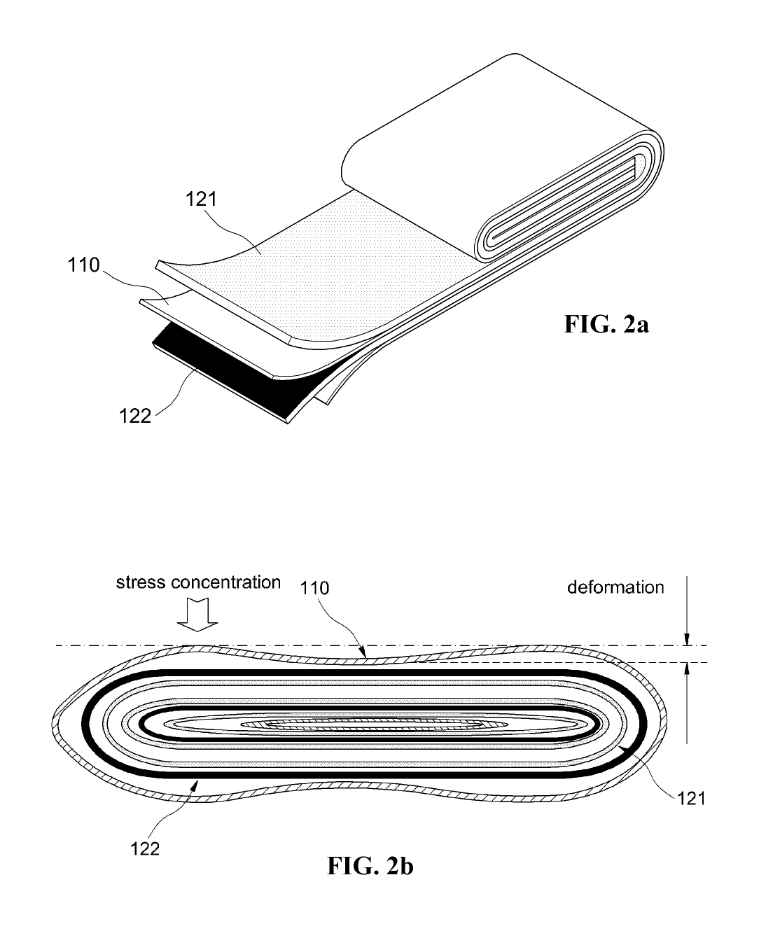

The same electrode material as that of the embodiment 1 was used, but an electrode stack was fabricated using the conventional winding method as shown in FIGS. 2A and 2B and a rechargeable battery using the electrode stacks was assembled.

<Evaluation of Lifespan and Characteristics of Batteries>

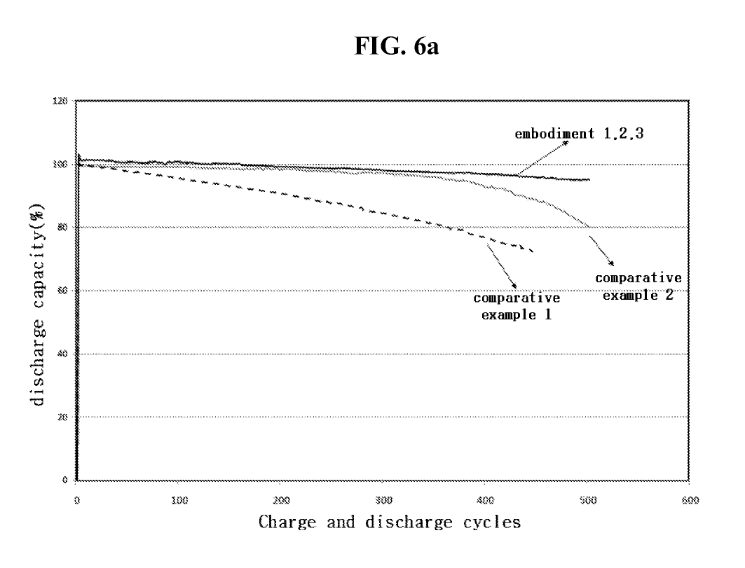

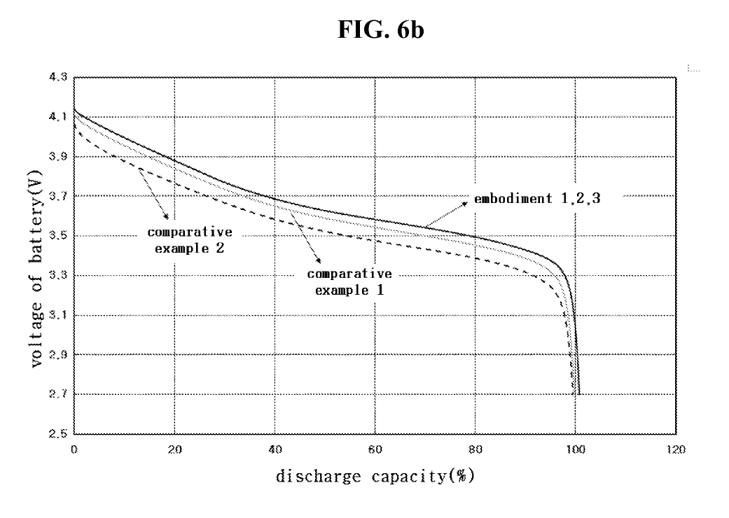

The batteries fabricated according to the embodiments and the comparative examples were subject to constant potential current regulated charging up to 4.2 V at 1.0 C for the battery design capacity and then subject to current regulated discharging up to 3.0 V at 1 C using a charge and discharge tester. In this state, the lifespan characteristic of the batteries was measured at normal temperature, and the measurement results were shown in FIG. 6A. As can be seen from FIG. 6A, the batteries according to the embodiments 1 to 3 had the remaining discharge capacity of 90% or more even after 500 charge and discharge cycles were performed because any marginal portion did not exist between the separation layer and each of the electrodes.

However, the battery fabricated using the zigzag method (comparative example 1) had an increased thickness resulting from a side reaction with the progress of a charge and discharge cycle and also had the remaining discharge capacity of only 70% in 450 charge and discharge cycles resulting from the exhaustion of an electrolyte because the anode electrode seceded from the cathode electrode. Furthermore, the battery fabricated using the winding method (comparative example 2) had a good charge and discharge cycle up to about 300 charge and discharge cycles, but had a very low remaining discharge capacity after 400 charge and discharge cycles because of the occurrence of internal stress and a twist effect and had the remaining discharge capacity of about 80% in 500 charge and discharge cycles.

The batteries fabricated according to the embodiments and the comparative examples were subject to constant potential current regulated charging up to 4.2 V at 1.0 C for the battery design capacity and then subject to current regulated discharging up to 3.0 V at 5 C using a charge and discharge tester. In this state, the output characteristic of the batteries was measured, and the measurement results were shown in FIG. 6B. Referring to FIG. 6B, in the case of the embodiments 1 to 3, assuming that a rated capacity was 1 C, in the case where the batteries were discharged to current five times greater than the rated capacity, an initial discharge voltage was 4.1 V or more, which had a low internal resistance. Furthermore, a discharge voltage curve upon discharging was higher than that of the comparative examples 1 and 2, and the discharge capacity was slightly higher than that of the comparative examples 1 and 2. In the case of the comparative examples 1 and 2, however, an initial discharge voltage was 4.1 V or less, which was much lower than that of the embodiments 1 to 3, meaning that the internal resistance of the battery is high. Furthermore, the discharge capacity was lower than that of the embodiments 1 to 3.

As described above, according to the rechargeable lithium ion batteries in accordance with the embodiments of the present invention, the electrode stack in which the arrangement of anode electrodes and cathode electrodes is not disordered because uniform stress is applied to the entire electrodes and separation layer. Accordingly, the lifespan of a rechargeable lithium ion battery using the electrode stack can be increased, and the input and output characteristic of the rechargeable lithium ion battery can be improved.

Although some exemplary embodiments of the present invention have been described, the present invention is not to be restricted by the embodiments and the accompanying drawings, but only by the appended claims. It is to be appreciated that those skilled in the art can change or modify the embodiments without departing from the scope and spirit of the present invention.

What is claimed is:

1. A method of manufacturing a electrode stack for a rechargeable lithium ion battery, the method comprising the steps of:
forming a unit electrode body by staking a separation layer to which predetermined tension force is applied along the longitudinal direction of said separation layer, a first electrode on a side of the separation layer, and a second electrode on the other side of the separation layer;
winding the unit electrode body by 180° around a rotation axis which is located at a center of the unit electrode body and is perpendicular to a longitudinal direction of the separation layer, thereby completing a first-step stack;
stacking a third electrode on the separation layer placed outside the first electrode and a fourth electrode on the separation layer placed outside the second electrode and then winding the unit electrode body by 180° around the same rotation axis in the same direction, thereby completing a second-step stack; and
stacking a predetermined number of electrodes through repetitive stacking and winding of the electrodes in the same manner and then driving both ends of the separation layer to one side, thereby completing a final electrode stack.

2. The method as claimed in claim 1, wherein:
the first electrode and the fourth electrode have a same polarity as an anode or a cathode, and the second electrode and the third electrode have a same polarity as a cathode or an anode, but have a different polarity from the first electrode and the fourth electrode.

3. The method as claimed in claim 1, wherein:
the first electrode and the second electrode of the unit electrode body are single side electrodes, and the single side electrodes are arranged so that inactive faces are opposed each other with the separation layer interposed there-between.

4. The method as claimed in claim 3, wherein the single side electrodes with the separation layer interposed there-between have anode and anode polarities, cathode and cathode polarities, or anode and cathode polarities, respectively.

5. An electrode stack for a rechargeable lithium ion battery fabricated according to claim 1.

6. An electrode stack for a rechargeable lithium ion battery fabricated according to claim 2.

7. An electrode stack for a rechargeable lithium ion battery fabricated according to claim 3.

8. An electrode stack for a rechargeable lithium ion battery fabricated according to claim 4.

9. A rechargeable lithium ion battery using the electrode stack according to claim 5.
